(19) United States
(12) Patent Application Publication
(10) Pub. No.: US 2007/0243223 A1
(43) Pub. Date: Oct. 18, 2007

(54) HYGIENIC AND/OR COSMETIC AND/OR DISINFECTANT COMPOSITION INCLUDING, AT LEAST ONE REPULSIVE AND/OR REPELLENT VERMIN-KILLER AGENT

(75) Inventors: Richard ALASRI, Ieper (BE); Woeter Goethals, Ieper (BE)

Correspondence Address: EGBERT LAW OFFICES, 412 MAIN STREET, 7TH FLOOR, HOUSTON, TX, 77002, US

(73) Assignee: CID LINES N.V., A French company, Ieper (BE)

(21) Appl. No.: 11/692,353

(22) Filed: Mar. 28, 2007

(30) Foreign Application Priority Data
Mar. 31, 2006 (FR) 06/02817

(51) Int. Cl. A01N 37/00

(52) U.S. Cl. 424/405; 514/560

(57) ABSTRACT

The present invention relates to a hygienic and/or cosmetic and/or disinfectant composition including, at least one repulsive and/or repellent vermin-killer agent. According to the invention, the repulsive and/or repellent agent is a fatty acid. The present invention also relates to the use of the composition as a vermin-killer and/or repulsive and/or repellent treatment composition for arthropods, in particular insects such as flies, when treating and/or washing the udders and/or the dug of mammals.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a hygienic and/or cosmetic and/or disinfectant composition including, at least one repulsive and/or repellent vermin-killer agent.

In particular, the present invention relates to a hygienic and/or cosmetic and/or disinfectant composition as a repulsive and/or repellent and/or vermin-killer agent for arthropods, in particular insects such as flies.

More particularly, the present invention relates to a hygienic and/or cosmetic and/or disinfectant composition, for treating and/or washing and/or spraying the udders and/or the dug, also known as mammary gland, of mammals.

2. Description of Related Art Including Information Disclosed Under 37 CFR 1.97 and 37 CFR 1.98.

The use of this type of compositions for dipping and/or washing the udders and/or the dug, also known as mammary gland, of mammals has been known for a long time. The use of such a composition intends to avoid and minimize mammitis.

Mammitisis an inflammation of the mammary gland of mammals, in particular milking cows, more or less acute to the penetration of bacteriae inside the dug. Mammitis is one of the diseases most widespread among milking cows and consequently causes heavy losses for breeders, in particular due to the fact that the mammitis-infected cow produces less milk, which will be, moreover, of lesser quality and will be sold at a very low price.

The penetration of bacteriae into the dug causing said mammitis, happens most often at the end of the milking operation when the sphincter, milk outlet orifice, is still open.

Today, to oppose this penetration of bacteriae, most breeders dip the udders of each cow with a filming and disinfectant product which will act as a barrier against micro-organisms.

Most dipping products known contain, on the one hand, a disinfectant active substance, which enables reduction of the bacterial load at the udders, on the other hand, emollients, to soften the skin of the udder, avoiding sore spots and thereby preventing the micro-organism from entering through said cracks, as well as a filming agent, which fixes the product to the udder and hence increases the contact time between the disinfectant and the surface to be treated.

Still, numerous factors may be responsible for the presence of bacteriae on the udder, such as for instance poor hand hygiene of the person in charge of the milking operation.

However, the inventor has noticed that other factors, without any relation with the hygiene of the farm, may be responsible for the occurrence of mammitis, for instance insects and, in particular flies which will, by stinging, propagate the bacteriae throughout the herd.

However, it appears that the compositions used today to prevent the occurrence of mammitis are not satisfactory, since they do not prevent the transmission of the infection by insects.

Moreover, antibiotic-based treatment also presents shortcomings, since this treatment is not always very efficient, wherein the bacteriae may develop certain resistance against them.

Besides, the consumers are often quite worried about the presence of antibiotics in animal products.

### BRIEF SUMMARY OF THE INVENTION

The purpose of the present invention is to provide a hygienic and/or cosmetic and/or disinfectant composition including, at least one repulsive and/or repellent vermin-killer agent which remedies the shortcomings aforementioned, in particular with regard to the transmission of infection by insects.

Another aim of the present invention is to offer a hygienic and/or cosmetic and/or disinfectant composition intended for mammals which prevents the occurrence of mammitis.

Another aim of the present invention is to offer ahygienic and/or cosmetic and/or disinfectant composition intended for human body and, in particular, for hair.

Other aims and advantages of the present invention will appear from the following description, given solely by way of example and without being limited thereto.

### DETAILED DESCRIPTION OF THE INVENTION

The present invention relates to a hygienic and/or cosmetic and/or disinfectant composition including, at least one repulsive and/or repellent vermin-killer agent.

According to the invention, said repulsive and/or repellent agent is a fatty acid.

One of the advantages of the composition as described in the present application lies in that it combines synergistically hygiene and/or cosmetic and/or disinfectant substances and a repulsive and/or repellent vermin-killer agent.

Fatty acids are carboxylic acids exhibiting a long hydrophobic chain which may be saturated or unsaturated.

According to a particular embodiment of the present invention, the fatty acid is oleic acid. Oleic acid is one of the most abundant of the long-chain fatty acids, and is in the form of a liquid (oil) which solidifies only at 4° C.

According to a particular embodiment of the present invention, said composition contains moreover emollients and/or a filming agent.

As already mentioned previously, emollients enable to soften the skin of the udder, avoiding sore spots, and thereby preventing the micro-organism from entering through said cracks.

Besides, the filming agent enables to fix said composition to the udder and hence to increase the contact time between the various constituents of the composition and the surface to be treated.

By way of non-limiting example, said composition according to the present invention may comprise, among others:
Iodine: 0.5%;
Emollients (glycerol and/or sorbitol): 5%; and
Oleic acid: 1%.

Another example of a composition, without being limited thereto, may comprise, among others:
Lactic acid: 3%;
Emollients (sorbitol and/or glycerol) : 5%;
Xanthan gum: 0.5%; and
Oleic acid: 1%.

Such a composition, as described in the present invention is used as a hygienic and/or cosmetic and/or disinfectant composition as a repulsive and/or repellent and/or vermin-killer agent for arthropods, in particular insects such as flies.

More particularly, such a composition, as described in the present invention is used as a composition for treating and/or washing udders and/or the dug of mammals.

In particular, said composition is used for treating by dipping and/or washing and/or spraying and/or foaming the udders of mammals.

In this view, treating and/or washing the udders of mammals before the milking operation is quite important in order to avoid any infection of the dug and/or udders by certain bacteriae. Indeed, the number of micro-organisms increases close to the orifice, or sphincter, of the udders.

It is then that hygiene and the milking procedures play an important role to prevent said microbes from penetrating into the zone. Such entry can be forced by the mechanical milking machine, especially at the end of the milking operation. Udders which are damaged or open too wide can be invaded more easily.

According to the present invention, the mammal may be any milking animal, such as any milking mammal, such as, for example, cow, ewe or goat, but the invention may be applied to other animals facing the same problems.

Obviously, other embodiments of the present invention, understandable to the man of the art, could have been contemplated without departing from the framework of the invention.

1. A hygienic and/or cosmetic and/or disinfectant composition, comprising:
at least one fatty acid being a repulsive and repellent for anthropods, in particular insects such as flies, when treating and washing udders or dug of a mammal.

2. The composition, according to claim 1, wherein said fatty acid is oleic acid.

3. The composition, according to claim 1, wherein said composition is dipped or washed or sprayed or foamed onto the udders of the mammal.

4. The composition, according to claim 3, wherein said mammal is a cow.

5. A composition, according to claim 3, wherein said mammal is a ewe.

6. A composition, according to claim 3, wherein said mammal is a goat.
